(19) United States
(12) Patent Application Publication
(10) Pub. No.: US 2010/0157167 A1
(43) Pub. Date: Jun. 24, 2010

(54) DISPLAY SYSTEM AND REMOTE CONTROL FOR USE THEREWITH

(76) Inventors: Joel S. Lawther, Pittsford, NY (US); Dale F. McIntyre, Honeoye Falls, NY (US); Richard G. Mackson, Pittsford, NY (US)

Correspondence Address: EASTMAN KODAK COMPANY;PATENT LEGAL STAFF, 343 STATE STREET, ROCHESTER, NY, 14650-2201, US

(21) Appl. No.: 12/339,108

(22) Filed: Dec. 19, 2008

(51) Int. Cl. H04N 5/44

(52) U.S. Cl. 348/734; 348/E05.096

(57) ABSTRACT

A display system includes a presentation display and a remote control for operating the presentation display. The remote control includes a connector for receiving a memory device and a preview display, the remote control can send wireless communications to said presentation display in a first mode for controlling the presentation display, and sending wireless communications to said presentation display in a second mode for displaying data stored in the memory device.

### FIELD OF THE INVENTION

This invention relates to the field of electronics, more specifically it relates to display systems and remote control devices for use therewith.

### BACKGROUND OF THE INVENTION

With the storage of picture data on tiny memory cards such as SD cards in a majority of digital still cameras, it is becoming a trend for these inexpensive cards to mount up in piles around the home, in drawers or in storage boxes. Today a very high storage capacity memory card is relatively inexpensive. Thus, it is easy to go and purchase more when a current one has reached its capacity. Currently, there are game systems such as the Nintendo Wii that accept SD cards for the viewing of pictures on a television set. Panasonic also has televisions that have memory card readers on the TV that can receive memory cards directly. However, previewing and scrolling through content with the audience present can lead to accidental sharing of photos and video that may not be intended for viewing by a television audience. Thus, what is needed is an easy solution to privately preview data in memory or external sources before displaying the data to the audience in front of the television.

### BRIEF DESCRIPTION OF THE DRAWINGS

FIG. 1 is a system view of a presentation display and remote control in accordance with an embodiment of the invention.

FIG. 2 is a block diagram for the method for displaying data on a presentation display in accordance with an embodiment of the invention.

FIG. 3 is a block diagram for a remote control in accordance with an embodiment of the invention.

### DETAILED DESCRIPTION OF THE INVENTION

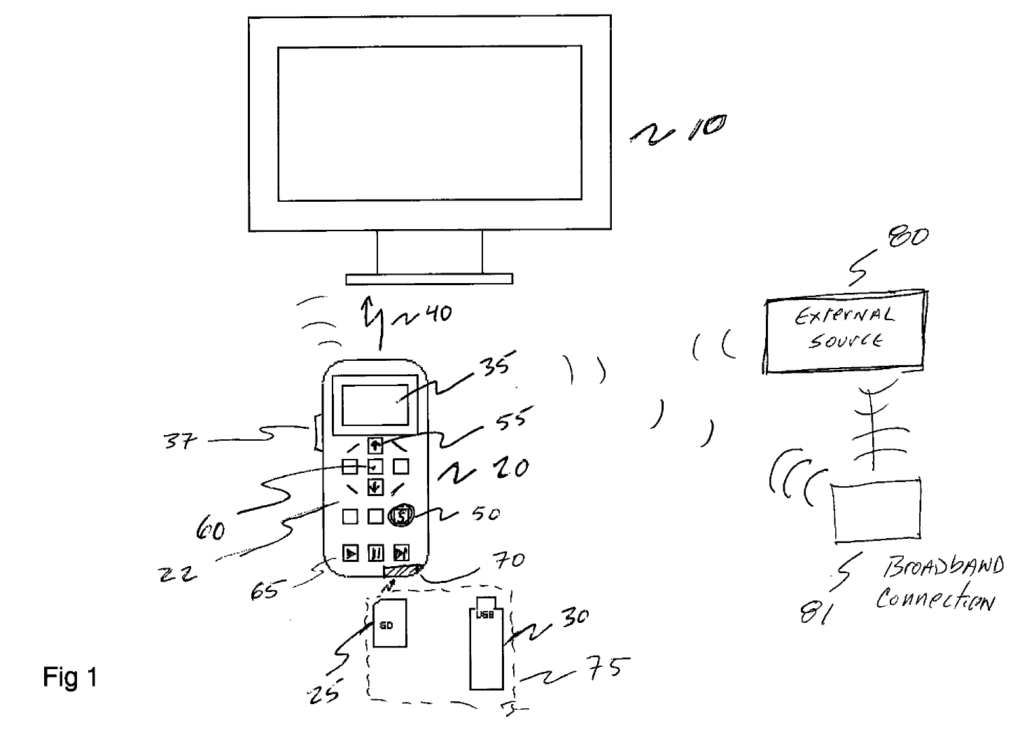

FIG. 1 illustrates a system view of a presentation display 10 and remote control 20 that can implement the present invention in one embodiment. In FIG. 1, the remote control 20 accepts memory device 75 such as an SD card 25 using an memory device input port such as a connector 70. Upon insertion of SD card 25, images stored as data within the card 25 are visible on preview display 35. Remote control 20 contains a user interface 22 including multiple control keys or switches such as 50, 55, 60 and 65 for data viewing and navigation. Using scroll buttons 55 a user can preview the images on preview display 35. Once data such as an image is chosen using preview display 35 for presentation display 10 viewing, a user can press the share button 50 for displaying the image on presentation display 10. Sending data such as images and video to presentation display 10 can be performed using a wireless protocol 40 of which an infrared protocol is a subset thereof. Examples of IrDA (Infrared Data Association), compliant infrared protocols include; IrSimple, and DeepCore which have been implemented in a wide range of devices, both consumer and industrial. Additional wireless protocols that can be used include, but are not limited to WIFI protocols and generations under the IEEE 802.11-based standards.

In one embodiment, when an image is sent to the presentation display 10 using share switch/button 50, the channel or input mode on presentation display 10 is changed to image or video viewing. Furthermore, videos can also represent data on the memory device 75. In the case of videos for transfer, remote control 20 can enable previewing the videos on preview display 35 in advance of sending the video to presentation display 10 when the send button 20 is depressed by a user. In another embodiment, the video is selected by the user using user interface 22. The user can play the video on the remote screen 35 using remote play button 65. Upon previewing the desired video clip, user presses send button 50 for viewing on presentation display 10. Also shown in FIG. 1, remote control 10 can also access data using wireless protocols from external source 80 for preview on preview display 35. External source 80 can be a computer such as a personal computer. This computer can be connected to a broadband connection 81. External source 80 can also be a remote server (not shown) in wireless connection with the remote control 20 providing images and video embedded in web pages via the internet.

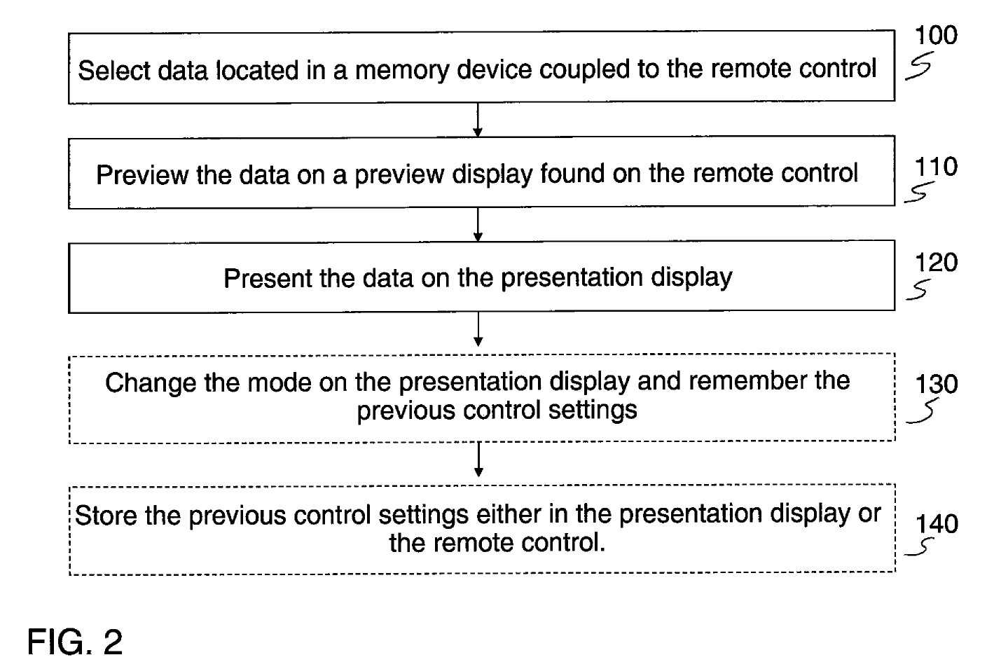

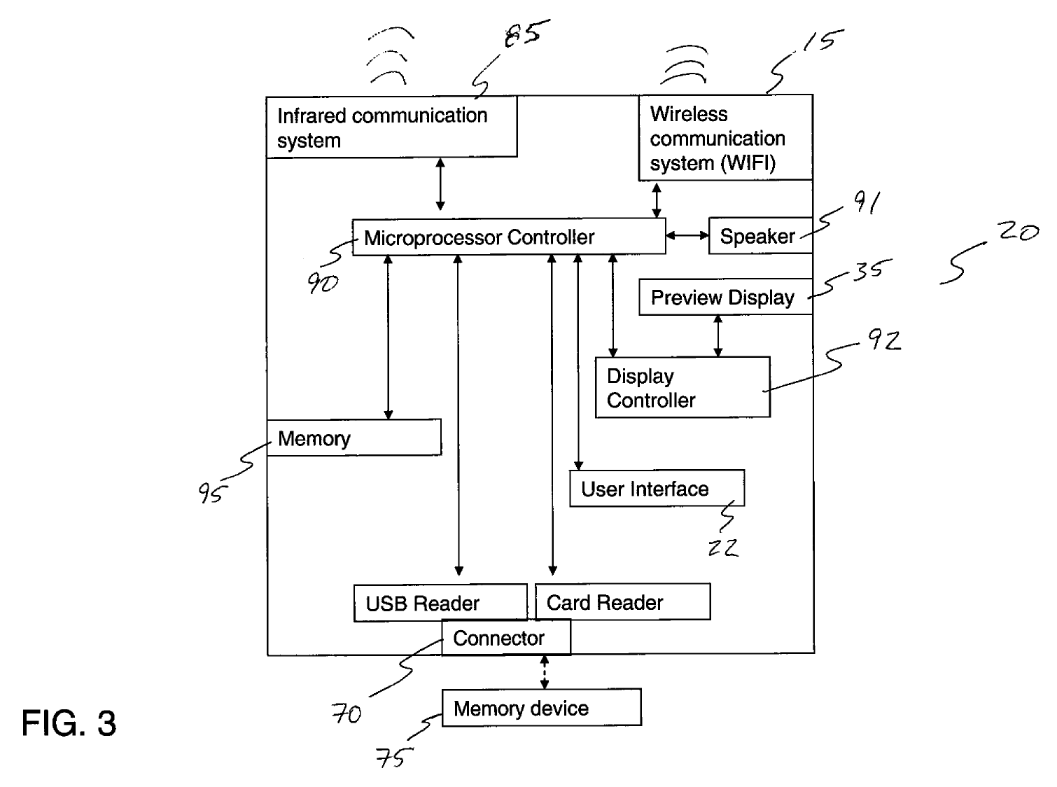

FIG. 2 is a block diagram for the method for displaying data on a presentation display 10 controlled by a remote control 20 in accordance with an embodiment of the invention. In block 100 memory device 75 is attached to connector 70 wherein the data within memory device 75 is selected using user interface 22. Memory device 75 can be a USB thumbdrive 30 or SD card 25 or similar portable digital data storage memory. In step 110, data such as videos, images, music and documents is previewed on the preview display 35. Upon approval of the data shown on preview display 35, the data is sent using share button 50 for presentation on the presentation display 120. Step 130 is an embodiment of changing the mode on the presentation display 10 saving the previous setting on the presentation display 10 and this saved data is recorded to memory 95 (shown on FIG. 3) on remote 20 or to memory device 75, (Step 135). In alternative embodiment, the previous settings can be stored in presentation display 10 using wireless communication system 15 (shown on FIG. 3) to transfer any previous control setting information to the presentation display 10. Previous control setting can include channel information, volume level, etc. Although not shown in the process, the remote control 20 can send a request to the external source 80 for “related data” shown in the preview display 35 or the presentation display 10. Related data can for example be data having some similarity or having associated data to a picture currently being displayed. As an illustrative example, if pictures of a birthday party are being displayed, the remote control 20 can query the metadata associated with the images and send a request to the external source 80 for images or videos having similar metadata information.

Referring now to FIG. 3, there is shown a block diagram for a remote control 20 of the present invention in accordance with another embodiment of the invention. Controller 90 which can comprise a microprocessor, microcontroller, etc., accesses data from memory device 75 via connector 70, data is then sent to display controller 92 for displaying on preview display 35. Controller 90 controls the operation of remote control 20 and can include control software stored therein or in external memory such as memory 95. User interface 22 enables control of data on preview display 35 and audio on speaker 91. Data is transferred via infrared communication system 85 and WIFI communication system 15 to presentation display 10 or external source 80. User interface 22 also enables control of data presented on presentation display 10. In one embodiment, Data on the preview display 35 can be manipulated using controls on the remote control 20 when mode switch 37 is set to control information on the preview display 35. Data on the presentation display 10 can be manipulated when mode switch 37 is set to control the data shown on the presentation display 10. In another embodiment, two sets of user interfaces 22 can be on remote control 20. One user interface 22 can be dedicated to data on preview display 35, wherein another user interface 22 can be dedicated to data on presentation display 35.

Additionally, data on remote source 80 or presentation display 10 can be stored to remote memory 95 or memory device 75 via connector 70. Data stored to the remote control memory 95 or memory device 75 from external source 80 can be then be manipulated and shared to presentation display 10 using share button 50 on remote 20. Remote control memory 95 can be sized to enable users to store their favorite images and video in the on-board memory for later sharing without locating a specific memory device 75.

The invention has been described in detail with particular reference to certain preferred embodiments thereof, but it will be understood that variations and modifications can be effected within the spirit and scope of the invention.

### PARTS LIST

10 presentation display
20 remote control
22 user interface
25 memory card
30 USB thumbdrive
35 preview display
37 mode switch
40 wireless protocol
50 send button
55 control key
60 control key
65 control key
70 input port/connector
75 memory device
80 external source
81 broadband connection
90 controller
91 speaker
92 display controller
95 memory
100 data selection
110 preview data
120 present data
130 change mode on presentation display
140 store previous control settings

1. A display system, comprising:
a presentation display;
a remote control for operating the presentation display, the remote control including a connector for receiving a memory device and a preview display, the remote control sending wireless communications to said presentation display in a first mode for controlling the presentation display, and sending wireless communications to said presentation display in a second mode for displaying data stored in the memory device.

2. A display system as defined in claim 1, wherein prior to wirelessly sending data stored in the memory device to the presentation display the data is displayed in the preview display.

3. A display system as defined in claim 2, wherein said data is not displayed in the presentation display prior to a user accepting the data displayed on the preview display.

4. A display system as defined in claim 1, wherein the data stored in the memory device comprises any one of the following: digital images; video; audio; motion images.

5. A display system as defined in claim 1, further comprising:
a wireless circuit located in the remote control for wirelessly receiving data from an external source, and sending said data to the presentation display.

6. A display system as defined in claim 5, wherein the remote control can control if the data in the memory device or the data received from the external source is displayed on the presentation display.

7. A display system in claim 5, wherein the remote control can store data received from the external source into the memory device.

8. A display system as defined in claim 5, wherein the remote control based on data presented to either the presentation display or the preview display can automatically send a request to the external source for related data.

9. A method for displaying data on a presentation display that is controlled by a remote control, comprising:
selecting data located in a memory device coupled to the remote control;
previewing the data on a preview display found on the remote control; and
presenting the data on the presentation display.

10. A method as defined in claim 9, wherein presenting the data on the presentation display causes the presentation display to change mode and remember the previous control settings.

11. A method as defined in claim 10, wherein the previous control settings are stored either in the presentation display or the remote control.

12. A remote control for controlling a display, comprising:
an input port for receiving a memory device;
a controller coupled to the input port;
a preview display coupled to the controller for previewing data stored in the memory device; and
an activation switch for causing data being previewed in the preview display to be presented in a remote presentation display and causing control setting for the presentation display to be stored.

13. A remote control as defined in claim 12, wherein the control setting are stored in a memory coupled to the controller.

14. A remote control as defined in claim 12, wherein the control setting are stored in the presentation display.

15. A remote control as defined in claim 12, further comprising:
a wireless communication system coupled to the controller, the wireless communication system receiving data to be presented to the preview display.
